(19) United States
(12) Patent Application Publication
(10) Pub. No.: US 2018/0268326 A1
(43) Pub. Date: Sep. 20, 2018

(54) OPTIMIZATION SYSTEM, OPTIMIZATION METHOD, AND OPTIMIZATION PROGRAM

(71) Applicant: NEC Corporation, Tokyo (JP)

(72) Inventors: Kenji AOKI, Tokyo (JP); Satoshi MORINAGA, Tokyo (JP)

(21) Appl. No.: 15/539,483

(22) PCT Filed: Nov. 25, 2015
(86) PCT No.: PCT/JP2015/005859

§ 371 Date: Jun. 23, 2017

(30) Foreign Application Priority Data
Dec. 26, 2014 (JP) 2014-264548

(51) Int. Cl. G06Q 10/04; G06F 17/50

(52) U.S. Cl. CPC G06Q 10/04; G06F 17/5009

(57) ABSTRACT

Provided is an optimization system capable of creating a large amount of data for optimization and specifying values of control variables in order to acquire an optimum result in consideration of uncertainty of predictive values. A simulation means 2 is given a model which is information modeling an object to be analyzed therein and including a parameter containing predictive values and their error ranges, control variables and an objective variable, determines values of the control variables per simulation for specifying a value of the objective variable, and conducts simulation multiple times based on the model. Further, the simulation means 2 determines definite values of the predictive values based on a random number and the parameter per simulation, and conducts simulation by use of values of the control variables and definite values of the predictive values. A control variable value specification means 3 specifies values of the control variables when the objective variable takes an optimum value.

### TECHNICAL FIELD

The present invention relates to an optimization system, an optimization method, and an optimization program for specifying values of control variables in order to acquire an optimum result.

### BACKGROUND ART

A technique for assuming a model in a data generation structure of an object to be analyzed, and machine-learning a value of a parameter included in the model by use of sample data acquired from the object to be analyzed is called machine learning. A model acquired by learning is used for prediction, knowledge finding, optimization, control, and the like, or used for determination.

It is assumed to employ simulation when a complicated system to be analyzed is optimized. With simulation, individual elements in an object to be analyzed are modeled and combined thereby to reproduce the object to be analyzed on a computer. Input data used for the simulation and output data by the simulation are used as sample data thereby to learn not the individual elements but the model assumed for the entire object to be analyzed, thereby realizing optimization by use of the model.

At this time, when the object to be analyzed is large-scaled and complicated, there is a problem that many items of input data need to be prepared and simulation needs to be tried many times in order to learn the model of the object to be analyzed with high accuracy. Therefore, various techniques for efficiently selecting input data into a simulator thereby to secure accuracy with a small number of times of trial are proposed (see Patent Literatures 1 to 3).

Patent Literature 1 describes therein a method for determining a value of a parameter for measuring optimization of a device with an optimization method and a data analyzation method by use of experiment results of the device and numerical simulation results of the device.

Patent Literature 2 describes therein a dataset selection device for enabling an experiment plan by an active learning method to be applied for a plurality of items of data for which datasets are previously defined.

Patent Literature 3 describes therein an experiment plan system capable of efficiently making an experiment plan by use of an active learning system.

### CITATION LIST

### Patent Literature

PTL 1: Japanese Patent Application Laid-Open No. 2003-281194

PTL 2: Japanese Patent Application Laid-Open No. 2007-304782

PTL 3: Japanese Patent Application Laid-Open No. 2007-304783

### SUMMARY OF INVENTION

### Technical Problem

While optimization is required, there are events which are difficult to optimize due to a less amount of available data. Such events will be listed below by way of example.

(Optimization of Natural Disaster Planning)

There is a need for analyzing influences of natural disasters such as earthquake and flood and making an optimum plan. However, events such as earthquake and flood rarely occur, and thus sufficient data cannot be acquired. In the example, a plan needs to be made before an event (natural disaster) actually occurs.

(Optimization of Social Infrastructure Maintenance Planning)

There is a need for analyzing influences of decrepit social infrastructures (such as damages of roads or bridges) and previously determining maintenance timings and priority of objects to be maintained. For example, however, events such as damages of roads or bridges rarely occur, and thus sufficient data cannot be acquired. It is necessary to make a maintenance plan before damage or the like actually occurs.

(Optimization of Order/Deployment Planning in Retail and Distribution)

There is a need for finding an optimum plan from among a large number of patterns of order/deployment plans. However, the past-executed order/deployment plans are generally followed, and thus only data for some specific plans can be acquired. Consequently, sufficient data for finding an optimum plan cannot be acquired.

(Optimization of Infrastructure Resource Supply Planning)

Resources or energy supplied to the public via infrastructures are denoted as infrastructure resources. For example, water, electricity, gas, and the like correspond to the infrastructure resources. There is a need for making a supply plan for supplying infrastructure resources such as water, electricity and gas at as low cost as possible. However, the past-executed plans are generally followed in many cases also for such a supply plan, and thus only data for some specific plans can be acquired. Consequently, sufficient data for finding an optimum plan cannot be acquired.

(Optimization of Infrastructure Resource Use Planning)

At customer side such as company, there is a need for clarifying when and how much an infrastructure resource such as water, electricity, and gas is used for minimizing cost for using infrastructure resources. That is, there is a need for making an optimum use plan. However, the past-executed plans are generally followed also for such a use plan, and thus only data for some specific plans can be acquired. Consequently, sufficient data for finding an optimum plan cannot be acquired.

Since sufficient data cannot be acquired for the above-listed events, there arises a problem that optimization is difficult. Further, when only data for some specific plans can be acquired, reliability of a made plan is lowered due to a bias based on the limited data.

Sufficient data may not be acquired due to high confidentiality of data. Sufficient data may not be acquired due to high cost for data acquisition. For example, social experiments for acquiring various data are assumed to be made. However, sufficient data may not be acquired due to high cost for the social experiments.

There is a technical system called mathematical programming problem. With the mathematical programming problem, the quantity to optimize or constraints on optimization are described in equations with objective function or constraint function, and the constraints are met thereby to analyze a status for giving optimum values. However, when the complicated social system or the like is to be analyzed as described above, the objective function or constraint function is difficult to describe in a mathematically-handleable form. This is because uncertain items such as occurrence of a disaster or prediction of a demand are contained as part of the system. For example, even if a certain predictive value is acquired, an error between the predictive value and an actual value occurs. Further, the value of the error is not constant.

In terms of the above, it is preferable that a technical problem for enabling much data for optimization to be created can be solved. Further, it is preferable that a technical problem for enabling optimization can be solved in consideration of uncertainty of predictive values.

It is therefore an object of the present invention to provide an optimization system, an optimization method, and an optimization program capable of creating much data for optimization and specifying values of control variables in order to acquire an optimum result in consideration of uncertainty of predictive values.

### Solution to Problem

An optimization system according to the present invention includes: a simulation means for receiving a model which is information modeling an object to be analyzed therein and including a parameter containing predictive values and their error ranges, control variables, and an objective variable, determining values of the control variables per simulation for specifying a value of the objective variable, and conducting the simulation multiple times based on the model; and a control variable value specification means for specifying values of the control variables when the objective variable takes an optimum value based on each value of the objective variable acquired by multiple simulations and each value of the control variables determined per simulation, and the simulation means determines definite values of the predictive values based on a random number and the parameter per simulation, and conducts simulation by use of values of the control variables and definite value of the predictive values.

An optimization method of the present invention includes the steps of: receiving a model which is information modeling an object to be analyzed therein and including a parameter containing predictive values and their error ranges, control variables, and an objective variable, determining value of the control variables per simulation for specifying a value of the objective variable, and conducting the simulation multiple times based on the model; specifying value of the control variables when the objective variable takes an optimum value based on each value of the objective variable acquired by multiple simulations and each value of the control variables determined per simulation; and determining definite values of the predictive values based on a random number and the parameter per simulation during simulation, and conducting simulation by use of values of the control variables and definite values of the predictive values.

An optimization program of the present invention causes a computer to perform: simulation processing of receiving a model which is information modeling an object to be analyzed therein and including a parameter containing predictive values and their error ranges, control variables, and an objective variable, determining values of the control variables per simulation for specifying a value of the objective variable, and conducting the simulation multiple times based on the model; and control variable value specification processing of specifying values of the control variables when the objective variable takes an optimum value based on each value of the objective variable acquired by multiple simulations and each value of the control variables determined per simulation, and definite values of the predictive values is determined based on a random number and the parameter per simulation, and simulation is conducted by use of value of the control variables and definite values of the predictive values in the simulation processing.

### Advantageous Effects of Invention

With the technical means according to the present invention, it is possible to acquire a technical effect of creating much data for optimization and specifying values of control variables in order to acquire an optimum result in consideration of uncertainty of predictive values.

### BRIEF DESCRIPTION OF DRAWINGS

FIG. 1 is a block diagram illustrating an exemplary optimization system according to a first exemplary embodiment of the present invention.

FIG. 2 is a schematic diagram illustrating exemplary values of control variables at each time determined before conducting a simulation.

FIG. 3 is a flowchart illustrating an exemplary processing progress of the optimization system.

FIG. 4 is a block diagram illustrating the exemplary optimization system according to a second exemplary embodiment of the present invention.

FIG. 5 is an explanatory diagram schematically illustrating exemplary information stored by a simulation means into a simulation progress storage means at individual times.

FIG. 6 is a schematic diagram illustrating exemplary values of control variables at each time determined before conducting a simulation.

FIG. 7 is a block diagram illustrating the exemplary optimization system according to a third exemplary embodiment of the present invention.

FIG. 8 is a schematic diagram illustrating exemplary values of an objective variable acquired in pre-processing.

FIG. 9 is a schematic block diagram illustrating an exemplary structure of a computer according to each exemplary embodiment of the present invention.

FIG. 10 is a block diagram illustrating an outline of an optimization system according to the present invention.

### DESCRIPTION OF EMBODIMENTS

Exemplary embodiments according to the present invention will be described below with reference to the drawings.

### First Exemplary Embodiment

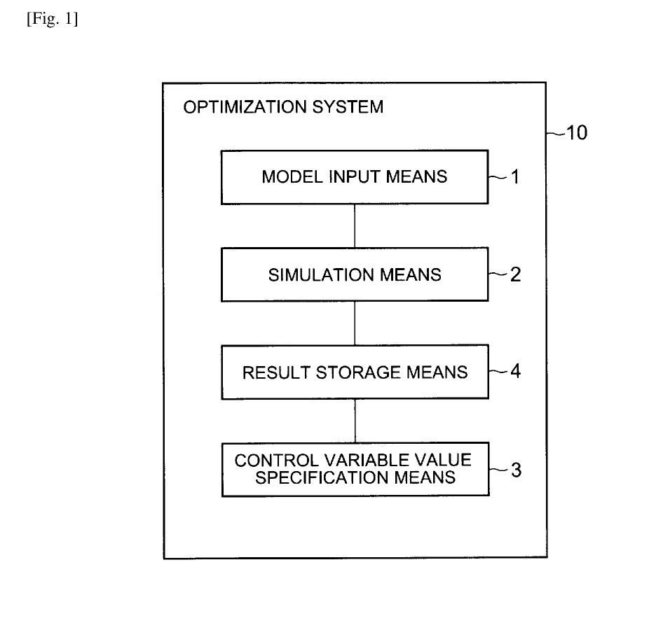

FIG. 1 is a block diagram illustrating an exemplary optimization system according to a first exemplary embodiment of the present invention. An optimization system 10 according to the present invention includes a model input means 1, a simulation means 2, a result storage means 4, and a control variable value specification means 3.

The model input means 1 is an input device for inputting a model used for simulation. The model is created by an analyst who wants to find an optimum value of a control variable.

The “model” according to the present invention is information in which an object to be analyzed is modeled in order to reproduce the object to be analyzed on a computer (the optimization system 10) by simulation.

The model includes a parameter, control variables, statuses, constraint conditions, and an objective variable.

The parameter is information for defining details of the model. The parameter includes predictive values and their error ranges used during simulation. The predictive values and their error ranges are expressed by predictive value probability distribution, for example. There will be described below an example in which the parameter includes predictive value probability distribution. For example, when a gas supply system is an object to be analyzed, the parameter includes probability distribution of a predictive value of the amount of remaining gas at a current time within each supply facility and a predictive value of the amount of demanded gas. The parameter may include not only the predictive values and their error ranges, but also information in which uncertain items (such as weather) are expressed in probability distribution. The predictive values and their error ranges may be acquired by machine learning, for example, but a method for deriving predictive values and their error ranges is not particularly limited.

Further, the parameter may include representative values of the predictive values together.

According to the present exemplary embodiment, there will be described an example in which predictive values and their error ranges are expressed in predictive value probability distribution. For the parameter, predictive values and their error ranges as well as uncertain items may be expressed in forms other than the probability distribution.

The analyst may define probability distribution of a predictive value and its error range depending on for which the predictive value is. For example, if a predictive value indicates the presence of occurrence of a disaster or accident, the analyst may define a predictive value and its error range in probability distribution based on Bernoulli distribution. For example, if a predictive value is for demand, the analyst may express a predictive value and its error range in probability distribution based on normal distribution.

The parameter may include predefined fixed values not only the information on predictive values (predictive values and their error ranges). That is, predictive values and their error ranges corresponding to variable elements may be contained in the parameter as part of the parameter.

The objective variable indicates an item to be optimized. For example, when a gas supply system is to be analyzed, a variable indicating gas supply cost may be the objective variable. The model includes the objective variables but does not include a value of the objective variable. A value of the objective variable is derived by simulation.

The control variables are directed for controlling a value of the objective variable in simulation. As in the above example, when gas supply cost is assumed as the objective variable, for example, a variable indicating a gas supply plan may be the control variable. This is because when the supply plan is changed, the supply cost is also changed. The number of control variables included in the model is not limited to one. The model includes control variables, but does not include values of the control variables. Values of the control variables are defined during simulation.

The control variable and the objective variable may be continuous variable or categorical variable. When the control variable or objective variable is a categorical variable, a value, which the control variable or objective variable may take, may not be a numerical value.

The status indicates a status at each step in simulation. For example, when a gas supply system is an object to be analyzed, the amount of remaining gas within each supply facility at each time, an operation situation of the supply facility at each time, and the like are listed as exemplary “status.” Which item is assumed as “status” is defined in the model, but specific contents of a status are determined when simulation is conducted. A step in simulation is a minimum time unit in the time for simulation. For example, when a simulation is conducted at granularity of hour for a gas supply system, the step in the simulation is one hour.

The constraint condition is a range of values which can be taken by the control variable, which is derived by the latest “status” and different from a domain.

The model includes information indicating a relationship (connection relationship) between elements configuring an object to be analyzed. The information can be called topology information. For example, when a gas supply system is to be analyzed, the model includes information indicating a relationship between each supply facility and each relay facility for gas. Further, the model includes identification information (such as facility name) for identifying the elements (each supply facility or each relay facility in the example), or constants (such as gas storage capacity) corresponding to the elements. The storage capacity and the like listed herein are constants, and are not used as control variables.

Further, the model includes a rule for defining statuses at each step, or a rule for determining a value of the objective variable. In order to simplify the description, there will be described herein an example in which the rules are if-then rules. With the rules, a value of the control variable or a definite value of the predictive value is described as condition. A definite value of the predictive value is determined by a probability distribution included in the parameter and a random number when simulation is conducted.

The description will be made below assuming that individual steps in simulation are indicated in time.

The analyst determines a model including various items of information as described above, and inputs it into the model input means 1. The model input means 1 sends the input model to the simulation means 2.

The simulation means 2 conducts simulation many times by use of the model. The simulation means 2 determines a value of each control variable at each time (each step) per simulation before conducting the simulation. FIG. 2 is a schematic diagram illustrating exemplary values of the control variables at each time determined before simulation is conducted. FIG. 2 illustrates the case in which two control variables are included in the model for simplified description. Further, FIG. 2 illustrates the case in which both of the values of “control variable 1” and “control variable 2” take “1” at each time, but the simulation means 2 may arbitrarily determine a value of each control variable at each time (each step) within a domain.

The simulation means 2 may collectively perform the operation of determining a value of each control variable at each time (each step) as many times as simulations.

After determining a value of each control variable at each time, the simulation means 2 sequentially determines the contents of statuses at individual time depending on the values of the control variables at individual time according to the rule for determining a status. When a definite value of the predictive value is used for the condition of the rule for determining a status, the simulation means 2 generates a random number, and determines a definite value of the predictive value by the value of the random number, and the probability distribution indicating the predictive value and its error range (included in the parameter), and may determine the contents of the status depending on the values of the control variables and the definite value of the predictive value. The simulation means 2 sequentially determines statuses at each time, and finally determines the value of the objective variable according to the rule for determining a value of the objective variable.

One combination of the parameter (the parameter in the model), the value of each control variable at each time, and the value of the objective variable is acquired with one simulation. The simulation means 2 stores the combination in the result storage means 4. The result storage means 4 is a storage device for storing simulation results.

If a value of the control variable at a time does not meet the constraint condition defined depending on the contents of the statuses at a previous time (or is not within the range under the constraint condition), the simulation means 2 stops the simulation in execution, and regards, as a simulation result, the fact that the value of the control variable in the simulation is not a candidate of the value of the control variable for optimizing the objective variable. The simulation means 2 then stores the combination of the parameter (the parameter in the model), the value of each control variable at each time and the information indicating that the value is not a candidate of the value of the control variable for optimizing the objective variable (which will be denoted as mismatch information below) in the result storage means 4.

The simulation means 2 repeatedly conducts the simulation many times by use of the model. Therefore, a large number of combinations of the parameter, the value of each control variable at each time, and the value of the objective variable are stored in the result storage means 4.

The number of times of simulation conducted by the simulation means 2 may be previously determined.

The control variable value specification means 3 specifies values of the control variables (a value of each control variable at each time) when the objective variable takes an optimum value based on a large number of combinations (the combinations of the parameter, the value of each control variable at each time, and the value of the objective variable) stored in the result storage means 4. The control variable value specification means 3 then outputs the values of the control variables. At this time, the control variable value specification means 3 may output not only the values of the control variables when the objective variable takes an optimum value, but also the optimum value of the objective variable.

For example, two methods may be assumed as a method in which the control variable value specification means 3 specifies a value of the control variable when the objective variable takes an optimum value.

The first method for specifying a value of the control variable when the objective variable takes an optimum value will be described below.

A value of the objective variable is assumed to be able to calculate in the following Equation (1) using the parameter and the control variable, for example.

Z=ax+by Equation (1)

z denotes an objective variable. x denotes a parameter. When a predictive value included in the parameter is assumed as x, a definite value of the predictive value is substituted into x. The simulation means 2 may contain the definite value of the predictive value in the information on the parameter in the simulation result stored in the result storage means 4. When a fixed value included in the parameter is assumed as x, the fixed value is substituted into x. y denotes a control variable. In Equation (1), only y is indicated as a symbol indicating the control variable, but if some control variables are present, the right side in Equation (1) increases according to the number of control variables. Even the same control variables are discriminated per time (per step) in an equation for calculating the objective variable. Therefore, the right side in Equation (1) increases also according to the number of steps.

The control variable value specification means 3 makes regression analysis by use of each combination of the parameter, the value of each control variable at each time, and the value of the objective variable with reference to the simulation result at each time (combination of the parameter, the value of each control variable at each time, and the value of the objective variable), and calculates the coefficients a and b in the right side in the equation for calculating a value of the objective variable as schematically illustrated in Equation (1). Consequently, the equation for calculating a value of the objective variable is acquired. The control variable value specification means 3 may ignore a simulation result including mismatch information when deriving an equation for calculating a value of the objective variable.

The control variable value specification means 3 calculates a value of each control variable at each time when the objective variable takes an optimum by use of the equation for calculating a value of the objective variable, the definite value of the predictive value or the predefined fixed value corresponding to x, and the constraint condition included in the model. The control variable value specification means 3 then outputs the value of each control variable at each time when the objective variable takes an optimum value, and the optimum value of the objective variable. When a predictive value included in the parameter is assumed as x in Equation (1), a representative value of the predictive value, or the top 95% point or bottom 95% point of the predictive value may be used.

The second method for specifying a value of the control variable when the objective variable takes an optimum value will be described below.

The control variable value specification means 3 may specify a combination in which the objective variable takes an optimum value with reference to the simulation result at each time (combination of the parameter, the value of each control variable at each time, and the value of the objective variable) thereby to specify a value of each control variable at each time included in the combination. The control variable value specification means 3 outputs a value of each control variable at each time when the objective variable takes an optimum value, and the optimum value of the objective variable.

The way the control variable value specification means 3 outputs a value of each control variable at each time when the objective variable takes an optimum value is not particularly limited. The control variable value specification means 3 may output a value of each control variable or an optimum value of the objective variable to be displayed on a display device (not illustrated). Alternatively, the control variable value specification means 3 may output a value of each control variable or an optimum value of the objective variable in a file form.

The simulation means 2 and the control variable value specification means 3 are realized by the CPU in a computer, for example. In this case, the CPU reads an optimization program from a program recording medium such as a program storage device (not illustrated in FIG. 1) in the computer, and may operate as the simulation means 2 and the control variable value specification means 3 according to the optimization program. Further, each means illustrated in FIG. 1 may be realized in separate hardware, respectively. This is applicable to each exemplary embodiment described below.

The optimization system 10 may be configured such that two or more physically-separated devices are connected in a wired or wireless manner. This is also applicable to each exemplary embodiment described below.

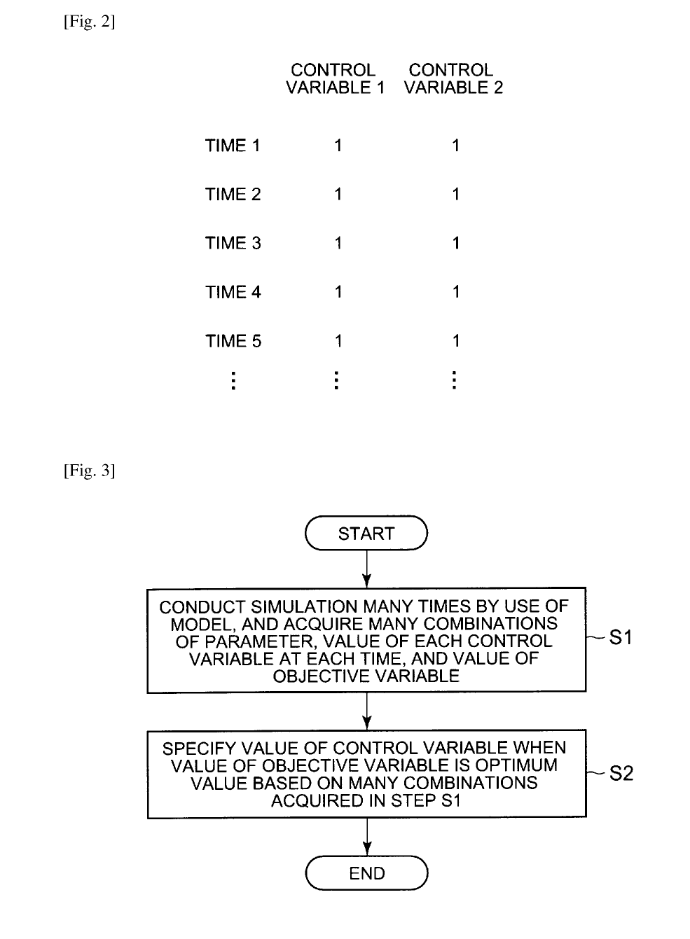

FIG. 3 is a flowchart illustrating an exemplary processing progress of the optimization system 10. When a model created by the analyst is input into the model input means 1, the model input means 1 sends the model to the simulation means 2. The simulation means 2 then conducts simulation many times by use of the model, and acquires a large number of combinations of the parameter in the model, the value of each control variable at each time, and the value of the objective variable (step S1). For example, the simulation means 2 arbitrarily defines a value of each control variable at each time (each step) in each simulation within the domain, and conducts the simulation. The simulation operation performed by the simulation means 2 has been already described, and thus the description thereof will be omitted herein. The simulation means 2 stores each combination acquired by conducting simulation many times in the result storage means 4.

The control variable value specification means 3 specifies values of the control variables (a value of each control variable at each time) when the objective variable takes an optimum value based on many combinations acquired in step S1 (step S2). The method for specifying values of the control variables when the objective variable takes an optimum value may employ the first method or the second method described above.

In step S2, the control variable value specification means 3 outputs the specified values of the control variables. At this time, the control variable value specification means 3 may output the optimum value of the objective variable together.

According to the present exemplary embodiment, the simulation means 2 defines a value of each control variable at each time (each step) in each simulation within the domain thereby to conduct simulation many times. Therefore, the simulation means 2 conducts simulations with a different value of each control variable at each time (each step) many times. Consequently, a large number of combinations of the parameter, the value of each control variable at each time, and the value of the objective variable are acquired. That is, a large amount of data for optimization (more specifically, data for specifying a values of the control variables when the objective variable takes an optimum value) can be acquired.

The parameter in the model includes predictive value and their error ranges. For example, the parameter includes probability distribution indicating a predictive value and its error range (probability distribution of predictive values). In order to acquire a definite value of the predictive value, the simulation means 2 generates a random number thereby to acquire a definite value by the random number and the parameter. Therefore, according to the present exemplary embodiment, simulation can be conducted in consideration of uncertainty of the predictive value, and consequently values of the control variables can be specified for acquiring an optimum result in consideration of the uncertainty of the predictive value.

### Second Exemplary Embodiment

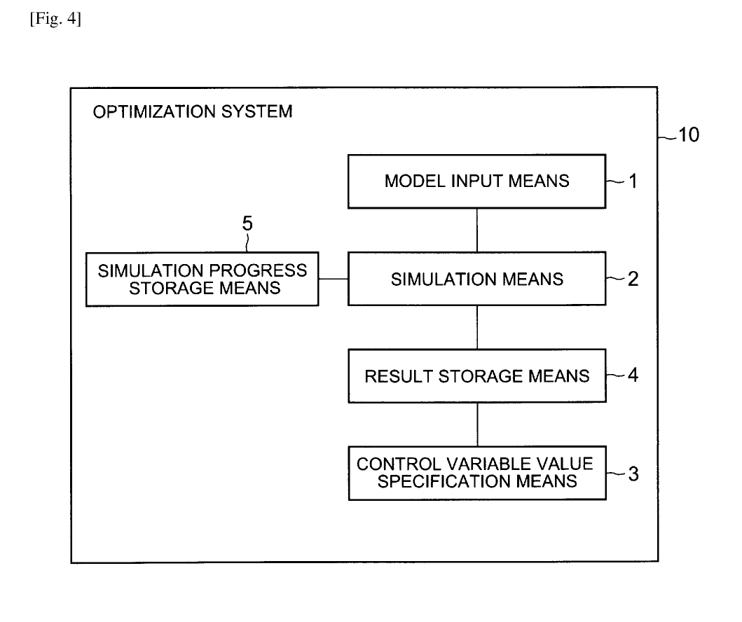

FIG. 4 is a block diagram illustrating the exemplary optimization system according to a second exemplary embodiment of the present invention. The description of the same components as in the first exemplary embodiment will be omitted.

An optimization system 10 according to the second exemplary embodiment includes the a model input means 1, simulation means 2, a result storage means 4, a control variable value specification means 3, and a simulation progress storage means 5. The model input means 1, the result storage means 4, and the control variable value specification means 3 are the same as the model input means 1, the result storage means 4, and the control variable value specification means 3 according to the first exemplary embodiment, and thus the description thereof will be omitted. According to the second exemplary embodiment, a method in which the control variable value specification means 3 specifies values of the control variables when the objective variable takes an optimum value may be the first method or the second method described above. Further, a model input into the optimization system 10 according to the second exemplary embodiment is also the same as the model according to the first exemplary embodiment, and thus the description thereof will be omitted.

The simulation progress storage means 5 is a storage device for storing information during simulation. The simulation progress storage means 5 and the result storage means 4 may be realized by the same storage device.

The simulation means 2 performs the operations described below in addition to the same operations as in the first exemplary embodiment. The description of the same operations by the simulation means 2 as in the first exemplary embodiment will be omitted. When determining statuses per time (per step), the simulation means 2 stores a value of each control variable at the time, and the contents of statuses determined depending on the control variables in association with the time in the simulation progress storage means 5. That is, the simulation means 2 stores a value of each control variable at an individual time, and the contents of statuses determined depending on the control variables in association with the time in the simulation progress storage means 5. The simulation means 2 performs the operation at each simulation.

FIG. 5 is an explanatory diagram schematically illustrating exemplary information stored by the simulation means 2 into the simulation progress storage means 5 at individual times. Similarly as in the case of FIG. 2, FIG. 5 illustrates the case in which two control variables are included in the model and both of the values of “control variable 1” and “control variable 2” at each time are “1.” As described according to the first exemplary embodiment, a value of each control variable at each time is determined before simulation is conducted.

For example, it is assumed that the simulation means 2 determines the contents of a status as “A” depending on the values of the control variable 1 and the control variable 2 at time 1. The simulation means 2 then stores the information “control variable 1=1, control variable 2=1, status=A” in association with time 1 in the simulation progress storage means 5. Subsequently, it is assumed that the simulation means 2 determines the contents of a status as “B” depending on the values of the control variable 1 and the control variable 2 at time 2. The simulation means 2 then stores the information “control variable 1=1, control variable 2=1, status=B” in association with time 2 in the simulation progress storage means 5. Similarly, the simulation means 2 stores a value of each control variable and the contents of a status determined depending on the value at each time in the simulation progress storage means 5 also after time 3.

Further, when conducting another simulation, the simulation means 2 compares a value of each control variable at each time in the simulation with the value of each control variable stored in association with time in the simulation progress storage means 5. When a value of each control variable in newly-conducted simulation matches with the value of each control variable stored in association with time in the simulation progress storage means 5 from the first time to a middle time in the simulation, the simulation means 2 reads the contents of the statuses at the last time when both match with each other from the simulation progress storage means 5. The simulation means 2 then conducts simulation from the next time by use of the statuses.

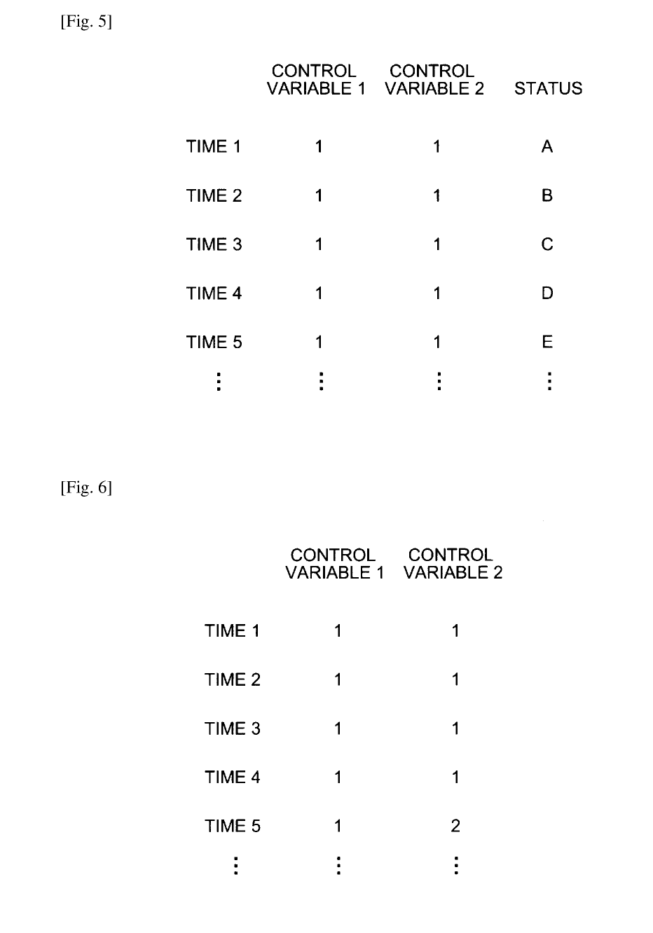

For example, it is assumed that as a result of a simulation, the information illustrated in FIG. 5 is stored in the result storage means 4. It is assumed that the values of the control variable 1 and the control variable 2 are determined at each time as illustrated in FIG. 6 for simulations conducted thereafter. That is, for a simulation to be newly conducted, it is assumed that both of the values of the “control variable 1” and the “control variable 2” at each time are “1” from time 1 to time 4, and the value of the “control variable 1” is “1” and the value of the “control variable 2” is 2 at time 5.

The simulation means 2 compares the values of the control variable 1 and the control variable 2 at each time illustrated in FIG. 6 with the values of the control variable 1 and the control variable 2 stored in association with each time in the simulation progress storage means 5 for the conducted simulations, and determines whether both match with each other from the first time to a middle time in the simulations. In the present example, the values of the control variable 1 and the control variable 2 in a simulation to be newly conducted match with the values of the control variable 1 and the control variable 2 in the conducted simulations stored in the simulation progress storage means 5 from time 1 to time 4. That is, the values of the control variable 1 match with each other and the values of the control variable 2 match with each other from time 1 to time 4 (see FIG. 5 and FIG. 6). Further, the value of the control variable 2 is different at time 5 (see FIG. 5 and FIG. 6). Therefore, the simulation means 2 reads the contents “D” of a status corresponding to the time (or time 4) when the values of the control variable 1 match with each other and the values of the control variable 2 match with each other after time 1 from the simulation progress storage means 5, and conducts a simulation at the next time to time 4 (or time 5) by use of the contents of the status.

When the values of the individual control variables match with each other between a simulation to be newly conducted and a conducted simulation from time 1 to a middle time as in the above example, the simulation means 2 omits the simulation to the middle time, and starts the simulation from the next time. Therefore, the amount of computations by the simulation means 2 can be reduced.

When a value of either control variable is different at first time 1 (first step) between a simulation to be newly conducted and a conducted simulation, the simulation means 2 may start a new simulation from time 1.

According to the present exemplary embodiment, the same effects as in the first exemplary embodiment can be obtained. Further, according to the present exemplary embodiment, the amount of computations by the simulation means 2 can be reduced as described above. Consequently, the number of times of simulation capable of being conducted within a certain period of time can be further increased than in the first exemplary embodiment.

### Third Exemplary Embodiment

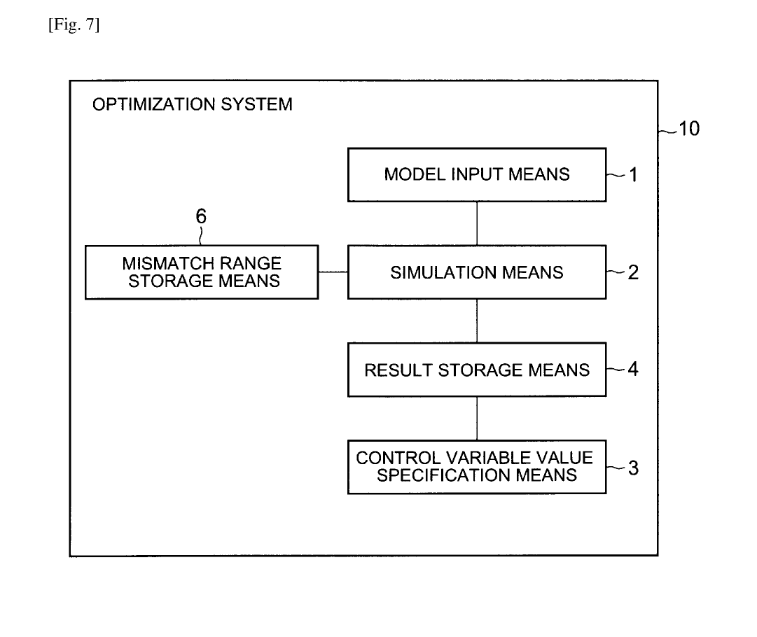

FIG. 7 is a block diagram illustrating the exemplary optimization system according to a third exemplary embodiment of the present invention. The description of the same components as in the first exemplary embodiment will be omitted as needed.

An optimization system 10 according to the third exemplary embodiment includes a model input means 1, a simulation means 2, a result storage means 4, a control variable value specification means 3, and a mismatch range storage means 6. The model input means 1, the result storage means 4, and the control variable value specification means 3 are the same as the model input means 1, the result storage means 4, and the control variable value specification means 3 according to the first exemplary embodiment, and thus the description thereof will be omitted. According to the third exemplary embodiment, the control variable value specification means 3 specifies a value of the control variable when the objective variable takes an optimum value in the second method.

According to the third exemplary embodiment, the optimization system 10 (specifically, the simulation means 2) specifies ranges of values of the control variables in which the objective variable does not take an optimum value as pre-processing. The range is denoted as mismatch range. The optimization system 10 then defines a value not belonging to the mismatch range as the value of the control variable in actual operation after the pre-processing, and conducts simulation.

The mismatch range storage means 6 is a storage device for storing a mismatch ranges specified in the pre-processing. The mismatch range storage means 6 and the result storage means 4 may be realized by the same storage device.

The simulation means 2 performs the operation in the pre-processing described below in addition to the same operations as in the first exemplary embodiment. The simulation means 2 performs the operations in actual operation (the same operations as in the first exemplary embodiment) after the pre-processing. Both in the pre-processing and in actual operation, the simulation means 2 conducts simulation by use of a model. The simulation operation is the same as the operation described according to the first exemplary embodiment, and thus the description thereof will omitted.

In the pre-processing, a plurality of models with different parameters is input into the model input means 1. The individual models are the same as the model according to the first exemplary embodiment. The parameter of each model is different, and the elements other than the parameter are common in each model. The analyst may create a plurality of models in which only the parameter is different in the pre-processing, and may input each model into the model input means 1.

The simulation means 2 defines various combinations of the values of control variables at each time to cover all the combinations in the pre-processing, for example. The simulation means 2 then conducts the simulation per combination for an individual model. In other words, the simulation means 2 conducts the simulation for each of the combinations for each parameter different per model.

The simulation means 2 specifies mismatch ranges (a range of values of each control variable in which the objective variable cannot take an optimum value) based on the value of the objective variable acquired as a result of the simulation, and stores the mismatch ranges in association with the parameter used for the simulation in the mismatch range storage means 6.

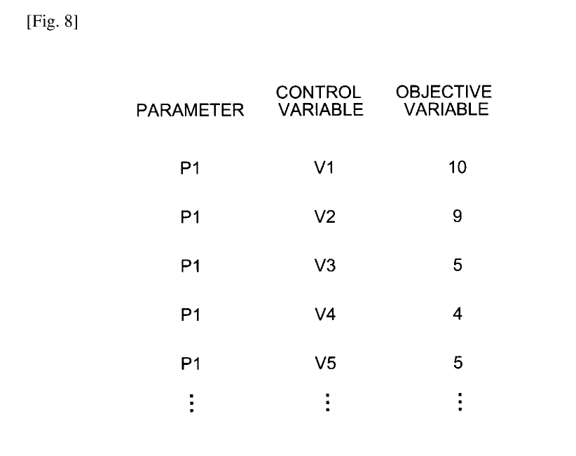

FIG. 8 is a schematic diagram illustrating exemplary values of the objective variable acquired in the pre-processing. In the present example, for the simplified description, it is assumed that the maximum value of the objective variable is “10” and the maximum value “10” is an optimum value of the objective variable. As the value is smaller than “10,” the value is less preferable for the objective variable. Further, for the simplified description, the description will be made assuming that only one control variable of “control variable 1” is used.

In the example illustrated in FIGS. 8, V1, V2, V3, V4, and V5 indicate a combination of values of the control variable 1 at each time. It is assumed that the values of the control variable 1 after time 2 are all common at 1 and the values of the control variable 1 at time 1 are different at V1, V2, V3, V4, and V5. For example, the values of the control variable 1 at time 1 of V1 to V5 are assumed as “1,” “2,” “3,” “4,” and “5,” respectively.

The parameter of a model is denoted as P1. In FIG. 8, the values of the objective variable acquired by conducting the simulation by use of V1, V2, V3, V4, V5, and the like are indicated for the model. The simulation means 2 determines a range of values of the control variable, for which a value of the objective variable is not present in a threshold range, as a mismatch range with reference to the optimum value of the objective variable. In the present example, it is assumed that the threshold is 3 and the simulation means 2 determines a range of values of the control variable in which a value of the objective variable is less than 7 (=10 ? 3) as a mismatch range.

In the example illustrated in FIG. 8, when the values of the control variable 1 after time 2 are all 1, if the values of the control variable 1 at time 1 are “1” and “2,” the values of the objective variable are “9” and “10” at time 1, respectively, and if the value of the control variable 1 at time 1 is “3” or more, the value of the objective variable is less than 7. From the above, the simulation means 2 determines that the mismatch range of the control variable 1 at time 1 is 3 or more when the values of the control variable 1 after time 2 are all 1, and stores the fact in the mismatch range storage means 6.

In the above example, the description has been made assuming the mismatch range for the control variable 1 at time 1 when the values of the control variable 1 after time 2 are all 1, but the simulation means 2 may similarly specify a mismatch range for the control variable 1 at time 1 when the values of the control variable 1 after time 2 are other than the above example.

In the above example, the description has been made assuming that a mismatch range for the control variable 1 at time 1 is specified, but a mismatch range of the control variable 1 at other time may be similarly specified.

In the above example, the description has been made assuming one control variable for simplified description, but a plurality of control variables may be present. In this case, for example, the simulation means 2 may change the value of the control variable 1 at time 1 and define a mismatch range for the control variable 1 at time 1 under the condition that the control variable 2 is “1” at time 1 and the values of the control variable 1 and the control variable 2 are “1” after time 2. Similarly, the simulation means 2 may define a mismatch range for the control variable 2 at time 2. Further, the simulation means 2 may variously change the condition, and similarly define a mismatch range for the control variable 1 or the control variable 2. Further, the simulation means 2 may similarly define a mismatch range for the control variable 1 or the control variable 2 at other time.

It is assumed that a value of the control variable at a time does not meet the constraint condition defined depending on the contents of the status at a previous time in the simulation in the pre-processing, and the simulation means 2 stops the simulation in execution and derives mismatch information. In this case, the simulation means 2 determines that the value of the control variable used for the simulation is also included in the mismatch range.

The simulation means 2 performs the processing of specifying a mismatch range described above per model input in the pre-processing.

As a result of the pre-processing described above, a mismatch range for the control variable under various conditions is stored in association with the parameter.

One model including an analyst-designated parameter is input by the analyst into the model input means 1 in actual operation after the pre-processing. The model input means 1 sends the model to the simulation means 2.

The simulation means 2 conducts simulation many times by use of the model. The simulation means 2 determines a value of each control variable at each time (each step) per simulation before conducting the simulation. At this time, the simulation means 2 determines a value not belonging to the mismatch range as the value of the control variable at each time (each step) with reference to the mismatch range corresponding to the parameter included in the model. Other operations in actual operation are the same as in the first exemplary embodiment. As described above, according to the third exemplary embodiment, the control variable value specification means 3 specifies a value of the control variable when the objective variable takes an optimum value in the second method.

According to the third exemplary embodiment, the simulation means 2 specifies mismatch ranges in the pre-processing, and determines a value not belonging to the mismatch range as the value of the control variable in actual operation. Therefore, a simulation using a value of the control variable for which the objective variable cannot take an optimum value is not conducted in actual operation, and thus a simulation for specifying values of the control variables when the objective variable takes an optimum value can be efficiently conducted.

The optimization system 10 according to the third exemplary embodiment includes the simulation progress storage means 5, and the simulation means 2 may perform the operations described according to the second exemplary embodiment in addition to the operations described according to the third exemplary embodiment. At this time, the simulation means 2 may perform the operations described according to the second exemplary embodiment not only during a simulation in actual operation but also during a simulation in the pre-processing. Further, the simulation means 2 may perform the operations described according to the second exemplary embodiment during a simulation in actual operation with reference to the mismatch range acquired in the pre-processing according to the third exemplary embodiment.

Various application examples of the present invention will be described below.

### Application Example 1

The present invention is applicable to determine how to use which solution (such as development of roads and bridges, reservation of basic necessities, evacuation guidance, or aid delivery) when a natural disaster such as earthquake or flood occurs in an area.

In this case, the analyst creates a model in which a natural disaster to occur in an area of interest is modeled. The analyst includes area information such as road network or population in the area, or information on the type of a natural disaster (such as earthquake or flood) assumed by the analyst in the model.

Further, the model includes, as the parameter, a predictive value and its error range of a disaster occurrence place, a predictive value and its error range of a magnitude of a disaster, a predictive value and its error range of a disaster occurrence time, or a people distribution and its error range in the area at the time of disaster occurrence. The information listed herein is exemplary, and the model may include part of the listed information, or other predictive value and its error range as the parameter. Further, the parameter may include a predefined fixed value.

The model includes a control variable indicating a development situation of roads and bridges, or a control variable indicating how to give evacuation guidance, for example. Further, the model may include a control variable indicating a reservation situation of basic necessities, or a control variable indicating an aid delivery method. The information listed herein is exemplary, and the model may include some of the listed control variables or other control variable as the control variable.

Further, the model includes, as the information on the type of a status, information for designating the number of the wounded at each time, a people distribution at each time, or a situation of damaged buildings, roads and bridges at each time, for example. The specific contents of each status at each time are determined during simulation. The information listed herein is exemplary, and the model may include part of the listed information or other information as the information on the type of a status.

The model includes, as the constraint condition, information indicating limitations on the evacuation guidance derived based on injury of evacuees, and damages of buildings, roads and bridges, for example. The information listed herein is exemplary, and the model may include part of the listed information or other constraint condition as the constraint condition.

Further, the model includes an objective variable indicating a time for evacuation, for example. The information listed herein is exemplary, and the model may include other objective variable.

When the above model is input, the simulation means 2 defines a value of each control variable included in the mode per simulation, and conducts simulation many times. The simulation means 2 then stores a combination of the parameter in the model, the value of each control variable at each time, and the value of the objective variable per simulation in the result storage means 4. The control variable value specification means 3 then specifies a value of the control variable when the objective variable takes an optimum value.

Definite values of the predictive values is determined during simulation. Therefore, even if the predetermined value of the control variables is common, definite values of the predictive values determined during simulation is different, and thus a resultant value of the objective variable may be different. Therefore, according to the present invention, the simulation means 2 may conduct simulation multiple times by use of the predetermined same values of the control variables. When the value of the objective variable is remarkably different even at the same value of the control variable, the control variable value specification means 3 may exclude the control variable from the candidates of a value of the control variable when the objective variable takes an optimum value. For example, it is assumed that the model includes a predictive value of behaviors of evacuees as the parameter in the present application example 1. It is assumed that when the simulation means 2 conducts simulation multiple times by use of the same value of the control variable, a time for evacuation (objective variable) is remarkably long in a simulation and a time for evacuation is remarkably short in another simulation due to a different definite value of the predictive value for behaviors of evacuees. Herein, when a worst value is defined as the value of the objective variable for the same value of the control variable, the control variable value specification means 3 excludes the value of the control variable from the candidates of a value of the control variable when the objective variable takes an optimum value.

Further, the optimization system 10 may be of the second exemplary embodiment or the third exemplary embodiment, or a combination thereof. For example, the control variable is assumed as how to give evacuation guidance. The simulation means 2 may store how to give evacuation guidance (such as arrangement of guidance goods or contents of evacuation announcement) and a status at each time during simulation in the simulation progress storage means 5 (see FIG. 4), and may read the status at the last time and start the simulation from the next time in another simulation when the way to give evacuation guidance is partly common.

### Application Example 2

The present invention is applicable to optimize a maintenance plan (such as order or timing of maintenance of each facility) for aging degradation of social infrastructures (such as roads, bridges, tunnels, and railways) in an area.

In this case, the analyst creates a model in which a road network and the use of each road or bridge (or the use of each railway) in an area of interest is modeled.

The model includes, as the parameter, a current deterioration situation of each facility, and a predictive value and its error range of a deterioration progress. The information listed herein is exemplary, and the model may include part of the listed information, or other predictive value and its error range as the parameter. Further, the parameter may include a predefined fixed value.

Further, the model includes a control variable indicating the order of maintenance, and a control variable indicating the timings of maintenance, for example. The information listed herein is exemplary, and the model may include some of the listed control variables or other control variable as the control variable.

The model includes, as the information on the type of a status, information for designating a deterioration situation of a facility at each time and the use of roads and bridges (or the use of each railway) at each time, for example. The specific contents of each status at each time are determined on simulation. The information listed herein is exemplary, and the model may include part of the listed information or other information as the information on the type of a status.

The model includes, as the constraint condition, information indicating an upper limit of cost for maintenance or an upper limit of resources for maintenance. The information listed herein is exemplary, and the model may include part of the listed information or other constraint condition as the constraint condition.

The model includes an objective variable indicating maintenance cost or an objective variable indicating the magnitude of damage due to poor development. The information listed herein is exemplary, and the model may include some of the listed objective variables or other objective variable as the objective variable. For example, the model may include an objective variable indicating the magnitude of an accident to occur, an objective variable indicating a reduction in consumer satisfaction, or an objective variable indicating the degree of decreased income.

When the above model is input, the simulation means 2 determines a value of each control variable included in the mode per simulation, and conducts simulation many times. The simulation means 2 then stores a combination of the parameter in the model, the value of each control variable at each time and the value of the objective variable per simulation in the result storage means 4. The control variable value specification means 3 then specifies a value of the control variable when the objective variable takes an optimum value.

As described above, according to the present invention, the simulation means 2 may conduct simulation multiple times by use of the predetermined same value of the control variable. Even if the value of the control variable is the same, a definite value of the predictive value for deterioration situation changes per simulation, and thus the objective variable (such as the magnitude of damage due to poor development) may vary. For example, when the magnitude of damage due to poor development is assumed as the objective variable, the magnitude of damage can be acquired by simulation in consideration of the uncertainty. Values of the control variables for acquiring an optimum result can be specified in consideration of the uncertainty.

Further, the optimization system 10 may be of the second exemplary embodiment or the third exemplary embodiment, or a combination thereof. For example, the control variable is assumed as the order of maintenance of roads or bridges in an area. The simulation means 2 may store values of the control variables and statuses at each time during simulation in the simulation progress storage means 5 (see FIG. 4), and may read the statuses at the last time and start simulation from the next time in another simulation when the value of the control variable is partly common. Further, the simulation means 2 may specify a mismatch range of the order of maintenance depending on a predictive value and its error range for a facility deterioration situation in the pre-processing.

### Application Example 3

The present invention is applicable to optimize order processing depending on a stock situation or sales prediction in retail, or to optimize an additional deployment plan depending on a stock situation or future shipment prediction for products or parts in each warehouse of a manufacturer having a plurality of warehouses over certain areas (such as nationwide).

For example, when trying to optimize order processing in retail, the analyst creates a model in which shops, products and order processing system is modeled.

The model includes, as the parameter, the quantity of stock at present, and a predictive value and its error range of future sales, for example. The information listed herein is exemplary, and the model may include part of the listed information, or other predictive value and its error range as the parameter. The parameter may include a predefined fixed value.

The model includes a control variable indicating the quantity of order per product, and a control variable indicating logic for determining an order timing per product. The information listed herein is exemplary, and the model may include some of the listed control variables or other control variable as the control variable.

The model may include, as the information on the type of a status, information for designating the quantity of product stock at each time, for example. The specific contents of a status at each time are determined on simulation. The information listed herein is exemplary, and the model may include other information as the information on the type of a status.

The model includes, as the constraint condition, information indicating the maximum number of products available in a shop, or information indicating an order (lot) unit, for example. The information listed herein is exemplary, and the model may include part of the listed information or other constraint condition as the constraint condition.

The model includes an objective variable indicating sales in a certain period of time, or an objective variable indicating a stock-out time, for example. The information listed herein is exemplary, and the model may include some of the listed objective variables or other objective variable as the objective variable.

For example, when trying to optimize an additional deployment plan in a manufacturer having a plurality of warehouses, the analyst creates a model in which the number of warehouses, transportation cost to each warehouse, a lead time and the like are modeled.

The model includes, as the parameter, the quantity of stock at present, and a predictive value and its error range of the quantity of future shipment, for example. The information listed herein is exemplary, and the model may include, as the parameter, part of the listed information, or other predictive value and its error range. The parameter may include a predefined fixed value.

The model includes a control variable indicating the quantity of deployment per product or part, and a control variable indicating logic for determining a deployment timing per product or part. The information listed herein is exemplary, and the model may include some of the listed control variables or other control variable as the control variable.

The model includes, as the information on the type of a status, information for designating the quantity of stock of products or parts at each time, for example. The specific contents of a status at each time are determined on simulation. The information listed herein is exemplary, and the model may include other information as the information on the type of a status.

The model includes, as the constraint condition, information indicating the maximum number of products or parts available in a warehouse, or information indicating the quantity of stock at a supplier. The information listed herein is exemplary, and the model may include part of the listed information or other constraint condition as the constraint condition.

The model includes an objective variable indicating the quantity of shipment or the quantity of waste in a certain period of time, for example. The information listed herein is exemplary, and the model may include some of the listed objective variables or other objective variable as the objective variable.

When the above model is input, the simulation means 2 determines a value of each control variable included in the model per simulation, and conducts simulation many times. The simulation means 2 then stores a combination of the parameter in the model, the value of each control variable at each time, and the value of the objective variable per simulation in the result storage means 4. The control variable value specification means 3 then specifies values of the control variables when the objective variable takes an optimum value.

As described above, according to the present invention, the simulation means 2 may conduct simulation multiple times by use of the predetermined same value of the control variable. Even if the value of the control variable is the same, a definite value of the predictive value for sales or a definite value of the predictive value for the quantity of shipment changes per simulation, and thus a value of the objective variable such as stock-out time or the quantity of waste may vary. For example, when the quantity of waste is assumed as the objective variable, the quantity of waste can be acquired by simulation in consideration of the uncertainty. Values of the control variables for acquiring an optimum result can be specified in consideration of the uncertainty.

The optimization system 10 may be of the second exemplary embodiment or the third exemplary embodiment, or a combination thereof. For example, it is assumed that a control variable indicating the type and number of products ordered or deployed at each time is used. The simulation means 2 may store values of the control variables and statuses at each time during simulation in the simulation progress storage means 5 (see FIG. 4), and may read the statuses at the last time and start simulation from the next time in another simulation when the value of the control variable is partly common. Further, the simulation means 2 may specify a mismatch range for the control variable in the pre-processing.

### Application Example 4

The present invention is applicable to optimize supply cost or the like of infrastructure resources such as water, electricity, and gas.

In this case, the analyst creates a model in which a supply system including an infrastructure resource supply network or each supply facility is modeled.

The model includes, as the parameter, the amount of remaining infrastructure resource at a current time in each supply facility, and a predictive value and its error range of a future demand of the infrastructure resource. The information listed herein is exemplary, and the model may include part of the listed information, or other predictive value and its error range as the parameter. Further, the parameter may include a predefined fixed value.

Further, the model includes a control variable indicating an infrastructure resource supply plan, for example. The information listed herein is exemplary, and the model may include other control variable.

Further, the model includes, as the information on the type of a status, the amount of remaining infrastructure resource in each facility at each time, or information for designating an operation status of each supply facility at each time, for example. The specific contents of each status at each time are determined on simulation. The information listed herein is exemplary, and the model may include part of the listed information or other information as the information on the type of a status.

Further, the model includes, as the constraint condition, information indicating an operation capability (such as pump output limit or pipeline flowrate limit) of a supply facility, for example. The information listed herein is exemplary, and the model may include part of the listed information or other constraint condition as the constraint condition.

Further, the model includes an objective variable indicating infrastructure resource supply cost, or an objective variable indicating a time in which a supplied infrastructure resource is lacking. The information listed herein is exemplary, and the model may include some of the listed objective variables or other objective variable as the objective variable. For example, the model may include an objective variable indicating supply plan correction work cost for the shortage of supplied infrastructure resource. Further, the infrastructure resource supply cost may be power cost.

When the above model is input, the simulation means 2 determines a value of each control variable included in the model per simulation, and conducts simulation many times. The simulation means 2 then stores a combination of the parameter in the model, the value of each control variable at each time, and the value of the objective variable per simulation in the result storage means 4. The control variable value specification means 3 then specifies values of the control variables when the objective variable takes an optimum value.

As described above, according to the present invention, the simulation means 2 may conduct simulation multiple times by use of the predetermined same value of the control variable. Even if the value of the control variable is the same, a definite value for infrastructure resource demand prediction changes per simulation, and thus the objective variable (such as supply plan correction work cost for the shortage of supplied infrastructure resource) may vary. For example, when the correction work cost is assumed as the objective variable, the correction work cost can be acquired by simulation in consideration of the uncertainty. Then, values of the control variables for acquiring an optimum result can be specified in consideration of the uncertainty.

The optimization system 10 may be of the second exemplary embodiment or the third exemplary embodiment, or a combination thereof. For example, it is assumed that the control variable is the amount of supplied infrastructure resource in each facility at each time. The simulation means 2 may store a value of the control variable and a status at each time during simulation in the simulation progress storage means 5 (see FIG. 4), and may read the status at the last time and start simulation from the next time in another simulation when the value of the control variable is partly common. Further, the simulation means 2 may specify a mismatch range of the infrastructure resource supply plan depending on a predictive value and its error range of the amount of remaining infrastructure resource, or a predictive value and its error range of dement in the pre-processing.

Further, application examples of the present invention are not limited to application example 1 to application example 4 described above.

For example, the analyst may input a model including a predictive value and its error range of the number of customers in an amusement park as a parameter, a customer guidance method or an arrangement of stuff in the amusement park as a control variable, and a waiting time of the customers as an objective variable into the optimization system 10. The optimization system 10 may then conduct simulation many times by use of the model, and may specify a value of the control variable for minimizing the waiting time of the customers.

For example, the analyst may input a model including a predictive value and its error range of a product price as a parameter, a product price as a control variable, and a sales performance or profit as an objective variable into the optimization system 10. The optimization system 10 may then conduct simulation many times by use of the model, and may specify a value of the control variable for maximizing the sales performance or profit.

For example, the analyst may input a model including a predictive value and its error range of industrial product quality as a parameter, a mechanical control method for manufacturing the products as a control variable, and product quality or cost as an objective variable into the optimization system 10. The optimization system 10 may then conduct simulation many times by use of the model, and may specify a value of the control variable for maximizing the quality or minimizing the cost.

For example, the analyst may input a model including a predictive value and its error range of financial rating as a parameter, and a portfolio as a control variable into the optimization system 10.

For example, the analyst may input a model including a predictive value and its error range of whether a customer cancels a contract as a parameter, a control variable indicating an advertisement activity, and an objective variable indicating the rate of cancelation of contract into the optimization system 10. The optimization system 10 may conduct simulation many times by use of the model, and may specify a value of the control variable for minimizing the rate of cancelation of contract, for example.

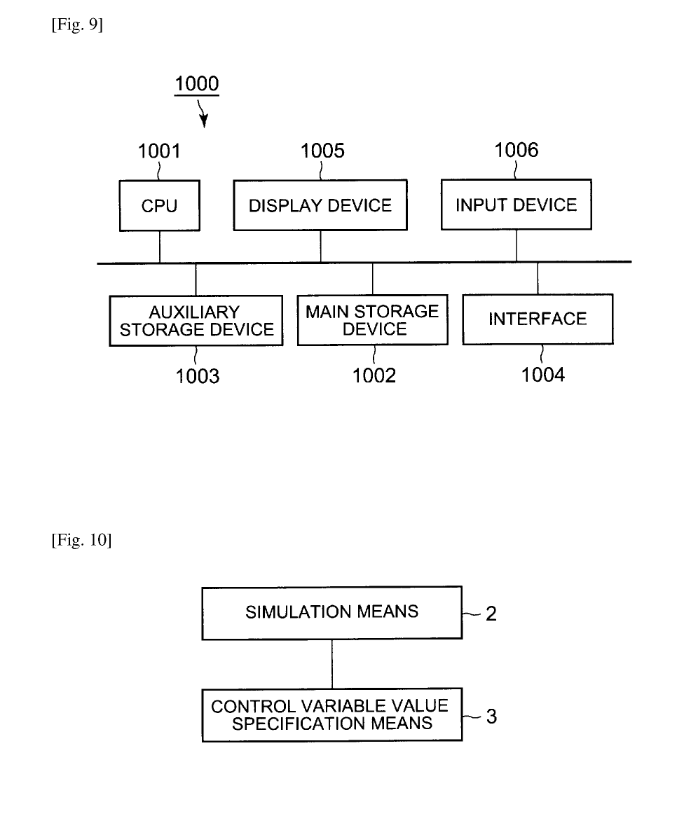

FIG. 9 is a schematic block diagram illustrating an exemplary structure of a computer according to each exemplary embodiment of the present invention. A computer 1000 includes a CPU 1001, a main storage device 1002, an auxiliary storage device 1003, an interface 1004, a display device 1005, and an input device 1006.

The optimization system 10 according to each exemplary embodiment is mounted on the computer 1000. The operations of the optimization system 10 are stored in the auxiliary storage device 1003 in the form of program (optimization program). The CPU 1001 reads and develops the program from the auxiliary storage device 1003 into the main storage device 1002, and performs the above processing according to the program.

The auxiliary storage device 1003 is an exemplary non-transitory tangible medium. Other exemplary non-transitory tangible media may include magnetic disk, magnetooptical disk, CD-ROM, DVD-ROM, semiconductor memory, and the like connected via the interface 1004. Further, when the program is distributed to the computer 1000 via a communication line, the computer 1000, which is distributed the program, may develop the program in the main storage device 1002, and perform the above processing.

Further, the program may be directed for realizing part of the processing. Furthermore, the program may be a differential program for realizing the processing in combination with other program already stored in the auxiliary storage device 1003.

FIG. 10 is a block diagram illustrating an outline of an optimization system according to the present invention. The optimization system according to the present invention includes the simulation means 2 and the control variable value specification means 3.

The simulation means 2 is given a model which is information modeling an object to be analyzed therein and including a parameter containing predictive values and their error ranges, control variables and an objective variable, determines values of the control variables per simulation for specifying a value of the objective variable, and conducts simulation based on the model multiple times.

The simulation means 2 determines definite values of the predictive values based on a random number and the parameter per simulation, and conducts simulation by use of the values of the control variables and the definite values of the predictive values.

The control variable value specification means 3 specifies values of the control variables when the objective variable takes an optimum value based on each value of the objective variable acquired by multiple simulations and each value of the control variables determined per simulation.

With the structure, a large amount of data can be created for optimization, and values of the control variables for acquiring an optimum result can be specified in consideration of uncertainty of the predictive values.

Each exemplary embodiment described above can be described as in the following supplementary notes, but is not limited to the following.

### Supplementary Note 1

An optimization system including a simulation means for receiving a model which is information modeling an object to be analyzed therein and including a parameter containing predictive values and their error ranges, control variables, and an objective variable, determining values of the control variables per simulation for specifying a value of the objective variable, and conducting the simulation multiple times based on the model, and a control variable value specification means for specifying values of the control variables when the objective variable takes an optimum value based on each value of the objective variable acquired by multiple simulations and each value of the control variables determined per simulation, wherein the simulation means determines definite values of the predictive values based on a random number and the parameter per simulation, and conducts simulation by use of values of the control variables and definite values of the predictive values.

### Supplementary Note 2

The optimization system according to supplementary note 1, wherein the simulation means determines values of the control variables per step in a simulation before conducting the simulation, stores values of the control variables corresponding to a step and a result of the step per step in a storage means when conducting the simulation, and when values of the control variables in a simulation to be newly conducted matches with the values of the control variables in a conducted simulation stored in the storage means for each step between a simulation start step and a middle step for the simulation to be newly conducted, starts the simulation to be newly conducted from a next step to the middle step by use of a result of the middle step in the conducted simulation.

### Supplementary Note 3

The optimization system according to supplementary note 1 or 2, wherein the simulation means conducts simulation multiple times per model by use of a plurality of models with different parameters as pre-processing, and specifies ranges of values of the control variables when the objective variable does not take an optimum value based on each value of the objective variable acquired by multiple simulations and each value of the control variables determined per simulation, and determines values of the control variables from outside the range corresponding to a model when given the model after the pre-processing and determining values of the control variables per simulation.

### Supplementary Note 4

The optimization system according to any one of supplementary notes 1 to 3, wherein the model includes a parameter containing a predictive value and its error range of a disaster occurrence place, a control variable indicating how to give evacuation guidance, and an objective variable indicating a time for evacuation.

### Supplementary Note 5

The optimization system according to any one of supplementary notes 1 to 3,wherein the model includes a parameter containing a predictive value and its error range of an infrastructure deterioration progress, a control variable indicating the order of maintenance of facilities included in the infrastructure, and an objective variable indicating maintenance cost.

### Supplementary Note 6

The optimization system according to any one of supplementary notes 1 to 3,wherein the model includes a parameter containing a predictive value and its error range of sales performance, a control variable indicating the quantity of order per product, and an objective variable indicating sales performance.

### Supplementary Note 7

The optimization system according to any one of supplementary notes 1 to 3, wherein the model includes a parameter containing a predictive value and its error range of a demand for an infrastructure resource as resource or energy supplied to the public by an infrastructure, a control variable indicating a supply plan for the infrastructure resource, and an objective variable indicating supply cost for the infrastructure resource.

The present invention has been described above with reference to the exemplary embodiments, but the present invention is not limited to the above exemplary embodiments. The structure and details of the present invention can be variously changed within the scope of the present invention understandable by those skilled in the art.

The present application claims the priority based on Japanese Patent Application No. 2014-264548 filed on Dec. 26, 2014, the disclosure of which is all incorporated herein by reference.

### INDUSTRIAL APPLICABILITY

The present invention is suitably applicable to an optimization system for specifying values of control variables in order to acquire an optimum result.

### REFERENCE SIGNS LIST

1 Model input means

2 Simulation means

3 Control variable value specification means

4 Result storage means

5 Simulation progress storage means

6 Mismatch range storage means

1. An optimization system comprising:
a simulation unit, implemented by a processor, for receiving a model which is information modeling an object to be analyzed therein and including a parameter containing predictive values and their error ranges, control variables, and an objective variable, determining values of the control variables per simulation for specifying a value of the objective variable, and conducting the simulation multiple times based on the model; and
a control variable value specification unit, implemented by a processor for specifying values of the control variables when the objective variable takes an optimum value based on each value of the objective variable acquired by multiple simulations and each value of the control variables determined per simulation,
wherein the simulation unit determines definite values of the predictive values based on a random number and the parameter per simulation, and conducts simulation by use of values of the control variables and definite values of the predictive values.

2. The optimization system according to claim 1,
wherein the simulation unit
determines values of the control variables per step in a simulation before conducting the simulation,
stores values of the control variables corresponding to a step and a result of the step per step in a storage unit when conducting the simulation, and
when values of the control variables in a simulation to be newly conducted matches with the values of the control variables in a conducted simulation stored in the storage unit for each step between a simulation start step and a middle step for the simulation to be newly conducted, starts the simulation to be newly conducted from a next step to the middle step by use of a result of the middle step in the conducted simulation.

3. The optimization system according to claim 1,
wherein the simulation unit
conducts simulation multiple times per model by use of a plurality of models with different parameters as pre-processing, and specifies ranges of values of the control variables when the objective variable does not take an optimum value based on each value of the objective variable acquired by multiple simulations and each value of the control variables determined per simulation, and
determines values of the control variables from outside the range corresponding to a model when given the model after the pre-processing and determining values of the control variables per simulation.

4. The optimization system according to claim 1,
wherein the model includes a parameter containing a predictive value and its error range of a disaster occurrence place, a control variable indicating how to give evacuation guidance, and an objective variable indicating a time for evacuation.

5. The optimization system according to claim 1,
wherein the model includes a parameter containing a predictive value and its error range of an infrastructure deterioration progress, a control variable indicating the order of maintenance of facilities included in the infrastructure, and an objective variable indicating maintenance cost,

6. The optimization system according to claim 1,
wherein the model includes a parameter containing a predictive value and its error range of sales performance, a control variable indicating the quantity of order per product, and an objective variable indicating sales performance.

7. The optimization system according to claim 1,
wherein the model includes a parameter containing a predictive value and its error range of a demand for an infrastructure resource as resource or energy supplied to the public by an infrastructure, a control variable indicating a supply plan for the infrastructure resource, and an objective variable indicating supply cost for the infrastructure resource.

8. An optimization method comprising the steps of:
receiving a model which is information modeling an object to be analyzed therein and including a parameter containing predictive values and their error ranges, control variables, and an objective variable, determining values of the control variables per simulation for specifying a value of the objective variable, and conducting the simulation multiple times based on the model;
specifying values of the control variables when the objective variable takes an optimum value based on each value of the objective variable acquired by multiple simulations and each value of the control variables determined per simulation; and
determining definite values of the predictive values based on a random number and the parameter per simulation during simulation, and conducting simulation by use of values of the control variables and definite values of the predictive values,

9. A non-transitory computer-readable recording medium in which an optimization program is recorded, the optimization program causing a computer to perform:
simulation processing of receiving a model which is information modeling an object to be analyzed therein and including a parameter containing predictive values and their error ranges, control variables, and an objective variable, determining values of the control variables per simulation for specifying a value of the objective variable, and conducting the simulation multiple times based on the model; and
control variable value specification processing of specifying values of the control variables when the objective variable takes an optimum value based on each value of the objective variable acquired by multiple simulations and each value of the control variables determined per simulation,
wherein definite values of the predictive values is determined based on a random number and the parameter per simulation, and simulation is conducted by use of values of the control variables and definite values of the predictive values in the simulation processing.
